(19) United States
(12) Patent Application Publication
(10) Pub. No.: US 2025/0064124 A1
(43) Pub. Date: Feb. 27, 2025

(54) HEATER AND CIGARETTE UTENSIL COMPRISING SAME

(71) Applicant: Shenzhen First Union Technology Co., Ltd., Shenzhen, Guangdong (CN)

(72) Inventors: Jiamao LUO, Shenzhen, Guangdong (CN); Zuqiang QI, Shenzhen, Guangdong (CN); Yangchang MU, Shenzhen, Guangdong (CN); Xinlei LI, Shenzhen, Guangdong (CN); Faqi WAN, Shenzhen, Guangdong (CN); Baoling LEI, Shenzhen, Guangdong (CN); Zhongli XU, Shenzhen, Guangdong (CN); Yonghai LI, Shenzhen, Guangdong (CN)

(73) Assignee: Shenzhen First Union Technology Co., Ltd., Shenzhen, Guangdong (CN)

(21) Appl. No.: 18/719,611

(22) PCT Filed: Dec. 2, 2022
(86) PCT No.: PCT/CN2022/136331

§ 371 Date: Jun. 13, 2024

(30) Foreign Application Priority Data
Dec. 13, 2021 (CN) 202123120797.3

(51) Int. Cl. A24F 40/46; A24F 40/20

(52) U.S. Cl. CPC A24F 40/46; A24F 40/20

(57) ABSTRACT

A heater and a cigarette utensil are provided. The heater includes: a base body; an electrically conductive coating, including a first electrode and a second electrode formed to be spaced apart on a surface of the base body; and an electric heating coating formed on the surface of the base body. Each of the first electrode and the second electrode includes a first portion and a second portion. The first portion of the first electrode and the first portion of the second electrode are both at least partially covered by the electric heating coating to be located between the surface of the base body and the electric heating coating, and are electrically connected to the electric heating coating. The second portion of the first electrode and the second portion of the second electrode are both exposed from the surface of the base body.

### CROSS-REFERENCE TO RELATED APPLICATIONS

This application claims priority to Chinese Patent Application No. 202123120797.3, filed with the China National Intellectual Property Administration on Dec. 13, 2021 and entitled “HEATER AND CIGARETTE UTENSIL COMPRISING SAME”, which is incorporated herein by reference in its entirety.

### TECHNICAL FIELD

This application relates to the technical field of cigarette utensils, and in particular, to a heater and a cigarette utensil including same.

### BACKGROUND

During use of smoking articles such as cigarettes or cigars, tobacco is burnt to produce smoke. An attempt has been made to provide substitutes for these tobacco-burning articles by producing products that release compounds without burning. An example of the products is a heat-not-burn product, which releases compounds by heating tobacco rather than burning the tobacco.

An existing low-temperature cigarette utensil including an electric heating coating heater or a thin film heater has the following problem. Since an electric heating coating is easily oxidized, forming an electrically conductive coating on the oxidized electric heating coating easily causes a relatively large contact resistance between the oxidized electric heating coating and the electrically conductive coating, resulting in a relatively large thickness and increased process costs of the electric heating coating.

### SUMMARY

This application provides a heater and a cigarette utensil including same, to resolve problems of a large thickness and high process costs of an electric heating coating of an existing cigarette utensil.

A first aspect of this application provides a heater, which includes:
a base body;
an electrically conductive coating, including a first electrode and a second electrode formed to be spaced apart on a surface of the base body; and
an electric heating coating, formed on the surface of the base body.

Each of the first electrode and the second electrode includes a first portion and a second portion. The first portion of the first electrode and the first portion of the second electrode are both at least partially covered by the electric heating coating to be located between the surface of the base body and the electric heating coating, and are electrically connected to the electric heating coating. The second portion of the first electrode and the second portion of the second electrode are both exposed from the surface of the base body.

Another aspect of this application, a terminal provides a cigarette utensil, which includes:
a chamber, configured to receive an aerosol-forming substrate; and
the above heater, configured to heat an aerosol-forming substrate to generate aerosols.

According to the heater and the cigarette utensil including same provided in this application, the first portion of the first electrode and the first portion of the second electrode are both at least partially arranged between the surface of the base body and the electric heating coating, so that problems of a large thickness and high process costs of the electric heating coating caused by a large contact resistance are avoided.

### BRIEF DESCRIPTION OF THE DRAWINGS

One or more embodiments are exemplarily described with reference to corresponding figures in drawings, and the exemplary descriptions are not to be construed as a limitation on the embodiments. Elements in the drawings having same reference numerals represent similar elements. Unless otherwise particularly stated, the figures in the drawings are not drawn to scale.

FIG. 1 is a schematic diagram of a cigarette utensil according to an implementation of this application.

FIG. 2 is a schematic diagram of a cigarette utensil and an aerosol generating article according to an implementation of this application.

FIG. 3 is a schematic diagram of a heater according to an implementation of this application.

FIG. 4 is a schematic diagram of a base body according to an implementation of this application.

FIG. 5 is a schematic diagram of a base body and an electrically conductive coating according to an implementation of this application.

FIG. 6 is a schematic diagram of an electrically conductive portion of a first electrode according to an implementation of this application.

### DETAILED DESCRIPTION

For case of understanding of this application, this application is described below in more detail with reference to drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. Terms “upper”, “lower”, “left”, “right”, “inner”, “outer”, and similar expressions used in this specification are merely used for illustration.

Unless otherwise defined, meanings of all technical and scientific terms used in this specification are the same as that usually understood by a person skilled in the art. Terms used in this specification of this application are merely intended to describe the specific implementations, and are not intended to limit this application. A term “and/or” used in this specification includes any or all combinations of one or more related listed items.

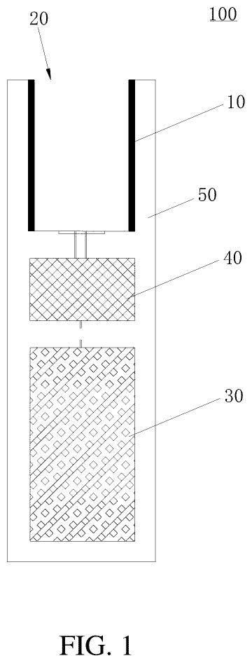

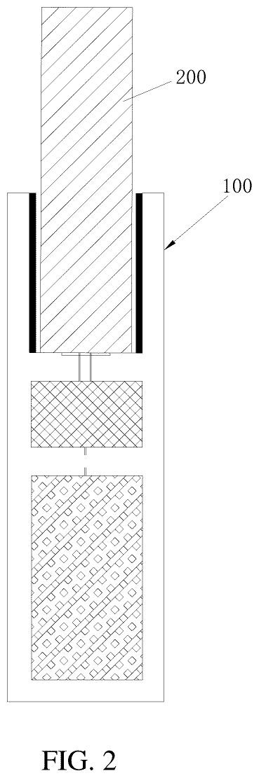

FIG. 1 and FIG. 2 show a cigarette utensil 100 according to an implementation of this application. The cigarette utensil includes a heater 10, a chamber 20, a battery core 30, a circuit 40, and a housing assembly 50. The heater 10, the chamber 20, the battery core 30, and the circuit 40 are all arranged in the housing assembly 50.

The heater 10 is configured to heat an aerosol-forming substrate.

The chamber 20 is configured to receive the aerosol-forming substrate.

The aerosol-forming substrate is a substrate that can release a volatile compound that can form an aerosol. The volatile compound may be released by heating the aerosol-forming substrate. The aerosol-forming substrate may be a solid or a liquid, or may include solid and liquid components. The aerosol-forming substrate may be loaded onto a carrier or a support through adsorption, coating, or impregnation, or in another manner. The aerosol-forming substrate may conveniently be a part of an aerosol generating article 200.

The battery core 30 supplies power for operating the cigarette utensil 100. For example, the battery core 30 can supply power to heat the heater 10. In addition, the battery core 30 can supply power for operating other elements provided in the cigarette utensil 100. The battery core 30 may be a rechargeable battery core or a disposable battery core.

The circuit 40 can control overall operations of the cigarette utensil 100. The circuit 40 not only controls operations of the battery core 30 and the heater 10, but also controls operations of the other elements in the cigarette utensil 100. For example, the circuit 40 obtains temperature information of the heater 10 sensed by a temperature sensor, and controls, based on the information, the power supplied by the battery core 30 to the heater 10.

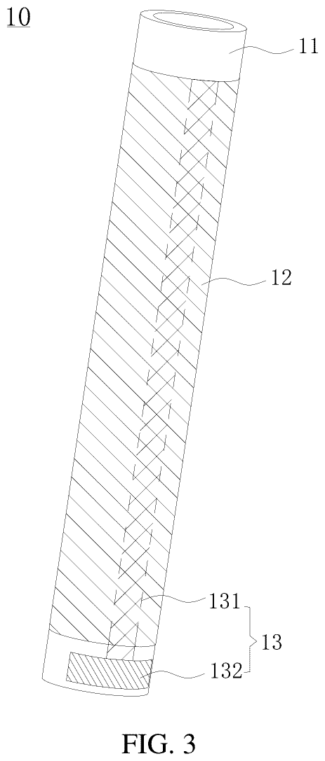

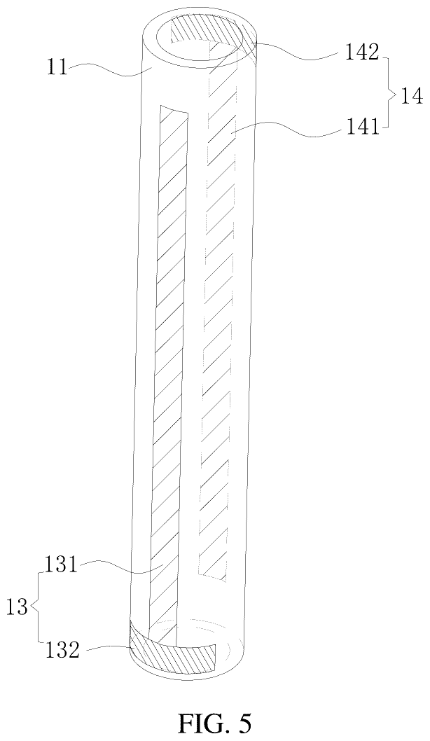

FIG. 3 and FIG. 5 show a heater according to an implementation of this application. The heater 10 includes a base body 11 and an electrically conductive coating and an electric heating coating formed on a surface of the base body 11. The electrically conductive coating is configured to connect to the battery core 30 to guide a current to the electric heating coating. In an optional example, the electric heating coating may include a resistance heating coating with a proper resistance or a thin film. The resistance heating coating generates joule heat when a current flows through the resistance heating coating, and transfers the joule heat to an aerosol-forming substrate through the base body 11. The resistance heating coating may be a complete film layer that covers a majority of the surface of the base body 11. Alternatively, the resistance heating coating may be constructed in a pattern with a specific shape. In an optional example, the electric heating coating includes an infrared electric heating coating 12. The infrared electric heating coating 12 is configured to generate an infrared ray when a current flows through the infrared electric heating coating, to radiatively heat the aerosol-forming substrate and generate aerosols.

In the following implementation, a description is provided by using a heater having an infrared electric heating coating as an example. In this example, the base body 11 includes a first end A, a second end B, and a surface extending between the first end A and the second end B. Inside of the base body 11 is a hollow 111 to form at least part of the chamber 20. The base body 11 may be in a shape of a cylinder or a prism, or another column shape. The base body 11 is preferably in the shape of a cylinder. The hollow 111 is a cylindrical hole. An inner diameter of the hole is slightly greater than an outer diameter of the aerosol generating article 200, so that the aerosol generating article 200 is placed in the hollow 111 for heating.

In an optional example, the base body 11 may be made of a high temperature-resistant and transparent material such as quartz glass, ceramic, or mica, or may be made of another material having a high infrared transmittance, for example, a high temperature-resistant material having an infrared transmittance above 95%, which is not specifically limited herein.

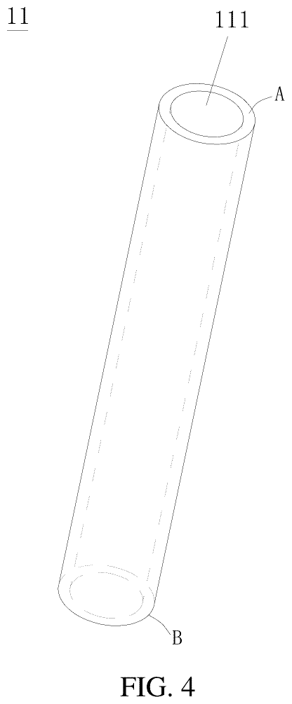

It should be noted that, different from the examples in FIG. 3 to FIG. 5, in other examples, the base body 11 may be in a shape of a plate or a semi-circular cylinder, which is also feasible.

It should be further noted that, different from the examples in FIG. 3 to FIG. 5, in other examples, the base body 11 may be made of a flexible material. In this way, the base body may be wound into a shape of a tube or another shape.

The infrared electric heating coating 12 is formed on the surface of the base body 11. The infrared electric heating coating 12 may be formed on an outer surface of the base body 11, or may be formed on an inner surface of the base body 11.

In this example, the outer surface of the base body 11 includes a first non-coating region, a coating region, and a second non-coating region. The first non-coating region is arranged adjacent to the first end A of the base body 11, the second non-coating region is arranged adjacent to the second end B of the base body 11, and the coating region is arranged between the first non-coating region and the second non-coating region.

The infrared electric heating coating 12 is formed in the coating region, which may be achieved through processes such as printing or vapor deposition. For example, the infrared electric heating coating 12 is formed in the coating region on the outer surface of the base body 11 through physical vapor deposition (PVD) or chemical vapor deposition (CVD), and covers at least part of the electrically conductive coating. The infrared electric heating coating 12 is configured to receive electric power to generate heat through the electrically conductive coating, thereby generating an infrared ray with a specific wavelength, for example, a far infrared ray with a wavelength in a range of 8 μm to 15 μm. When a wavelength of the infrared ray matches an absorption wavelength of the aerosol-forming substrate, energy of the infrared ray can be easily absorbed by the aerosol-forming substrate, thereby generating inhalable aerosols. A thickness of the infrared electric heating coating 12 is in a range of 100 nm to 30 μm, a range of 300 nm to 3 μm, a range of 500 nm to 2 μm, or a range of 800 nm to 1 μm. Further, to avoid oxidation of the infrared electric heating coating 12, an anti-oxidation layer may be formed on the infrared electric heating coating 12. The anti-oxidation layer may be composed of materials such as silicon oxide and aluminum oxide.

The electrically conductive coating includes a first electrode 13 and a second electrode 14 arranged to be spaced apart on the base body 11, which are configured to feed electric power to the infrared electric heating coating 12.

In this example, the electrically conductive coating may be selected from materials such as silver, gold, palladium, platinum, copper, nickel, molybdenum, tungsten, niobium, and an alloy of the metals, and is formed through processes such as printing or PVD. The first electrode 13 may be used as a positive electrode, and the second electrode 14 may be used as a negative electrode. After the first electrode 13 is energized, electric power can flow to the second electrode 14 through the infrared electric heating coating 12.

The first electrode 13 includes an electrically conductive portion 131 (a first portion) and a coupling portion 132 (a second portion). The second electrode 14 includes an electrically conductive portion 141 (a first portion) and a coupling portion 142 (a second portion). During actual production, the electrically conductive portion 131 and the coupling portion 132 of the first electrode 13 may be integrally formed through a mold, or may be formed successively, which is also feasible.

The coupling portion 132 and the coupling portion 142 are both configured to be coupled to the battery core 30. The coupling portion 132 is arranged in the second non-coating region, and the coupling portion 142 is arranged in the first non-coating region, that is, both of which are not in contact with the infrared electric heating coating 12. The coupling portion 132 and the coupling portion 142 are both constructed to extend in a circumferential direction of the base body 11, to form an arc-shaped electrode. It may be easily figured out that, in other examples, the coupling portion 132 and the coupling portion 142 both can form an annular electrode.

The electrically conductive portion 131 extends toward the first end A from the coupling portion 132 in an axial direction (that is, in a length direction of the base body 11) to form an elongated electrode. The electrically conductive portion 141 extends toward the second end B from the coupling portion 142 in the axial direction to form an elongated electrode. In other examples, the electrically conductive portion 131 and the electrically conductive portion 141 may spirally extend to form a spiral electrode. A thread pitch of the spiral electrode is adjustable, which facilitates electricity conduction of the infrared electric heating coating 12.

The electrically conductive portion 131 and the electrically conductive portion 141 are symmetrically arranged with respect to each other on the outer surface of the base body 11, and extending lengths of the electrically conductive portion 131 and the electrically conductive portion 141 in the axial direction are greater than an extending length of the infrared electric heating coating 12 in the axial direction. A part of the electrically conductive portion 131 and a part of the electrically conductive portion 141 are both covered by the infrared electric heating coating 12 to be located between the outer surface of the base body 11 and the infrared electric heating coating 12. In other words, a part of the electrically conductive portion 131 and a part of the electrically conductive portion 141 are both formed in the coating region. The coupling portion 132, the coupling portion 142, another part of the electrically conductive portion 131, and another part of the electrically conductive portion 141 are all exposed from the outer surface of the base body 11. The part of the electrically conductive portion 131 and the part of the electrically conductive portion 141 are both in contact with the infrared electric heating coating 12 to form electrical connection. In this way, the electric power provided by the battery core passes through the part of the electrically conductive portion 131, and flows circumferentially to the part of the electrically conductive portion 141 through the infrared electric heating coating 12.

In this example, each of the electrically conductive portion 131 and the electrically conductive portion 141 has a width ranging from 1 mm to 3 mm. Since the part of the electrically conductive portion 131 and the part of the electrically conductive portion 141 are both covered by the infrared electric heating coating 12, to avoid impact on radiation of an infrared ray to the hollow 111 as a result of occupation of an excessive area by the part of the electrically conductive portion 131 and the part of the electrically conductive portion 141, each of the electrically conductive portion 131 and the electrically conductive portion 141 may be designed with a width as small as possible. For example, the width may be in a range of 1 mm to 2.5 mm, or a range of 1 mm to 2 mm.

In a preferred implementation, the electrically conductive portion 131 and the electrically conductive portion 141 may be made of materials with desirable conductivity and a high infrared transmittance, such as silver, gold, platinum, or copper. Each of the electrically conductive portion 131 and the electrically conductive portion 141 has a thickness less than 1 μm, or less than 800 nanometers, or less than 700 nanometers, or less than 500 nanometers, or less than 300 nanometers, or less than 100 nanometers. In this way, the infrared ray irradiated by the infrared electric heating coating 12 can directly penetrate through the electrically conductive portion 131 or the electrically conductive portion 141 to the outer surface of the base body 11, and then radiate toward the hollow 111 through the base body 11.

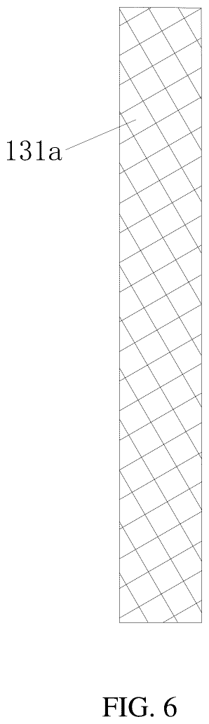

In another preferred implementation, the electrically conductive portion 131 and the electrically conductive portion 141 both may be an electrode with a light transmitting gap, so that the infrared ray irradiated by the infrared electric heating coating 12 can pass through the light transmitting gap and arrive at the outer surface of the base body 11, and then radiate toward the hollow 111 through the base body 11. The electrically conductive portion 131 is used as an example. As shown in FIG. 6, the electrically conductive portion 131 is a patterned electrode with a mesh shape 131a. The mesh shape 131a is a quadrangle. Certainly, the mesh shape 131a may be at least one of a circle, an ellipse, a triangle, a polygon, and an irregular shape.

In the examples of FIG. 3 to FIG. 6, the electrically conductive portion 131 and the electrically conductive portion 141 both extend in an axial direction. Different from the examples of FIG. 3 to FIG. 6, in other examples, the electrically conductive portion 131 and the electrically conductive portion 141 may extend in the circumferential direction of the base body 11, to form an annular electrode. In this way, the electric power provided by the battery core passes through the part of the electrically conductive portion 131, and flows axially toward the electrically conductive portion 141 through the infrared electric heating coating 12.

In the examples of FIG. 3 to FIG. 6, the coupling portion 132 and the coupling portion 142 are located on different ends of the base body 11. Different from the examples of FIG. 3 to FIG. 6, in other examples, the coupling portion 132 and the coupling portion 142 may be located on a same end of the base body 11, for example, the second end B of the base body 11.

In the examples of FIG. 3 to FIG. 6, the coupling portion 132 and the coupling portion 142 both extend in the circumferential direction. Different from the examples of FIG. 3 to FIG. 6, in other examples, the coupling portion 132 and the coupling portion 142 may extend in a length direction of the base body 11, to form a strip-shaped electrode, which is also feasible. It should be noted that, shapes of the coupling portion 132 and the coupling portion 142 are not limited to the above examples.

In another example, the electrically conductive coating further includes a third electrode (not shown in the figure). The third electrode includes an electrically conductive portion and a coupling portion.

The electrically conductive portion of the third electrode is at least partially covered by the infrared electric heating coating 12 to be located between the outer surface of the base body 11 and the infrared electric heating coating 12, and is electrically connected to the infrared electric heating coating 12. The coupling portion of the third electrode is exposed from the outer surface of the base body 11.

The infrared electric heating coating 12 includes a first electric heating coating located between the first electrode 13 and the third electrode and a second electric heating coating located between the second electrode 14 and the third electrode. The first electric heating coating and the second electric heating coating can independently heat different parts of an aerosol-forming substrate, to achieve section-by-section heating.

It should be noted that, the first electric heating coating and the second electric heating coating may be a consecutive coating, and are segmented into a plurality of coatings by the first electrode 13, the second electrode 14, and the third electrode. Similarly, the first electric heating coating and the second electric heating coating may be inconsecutive coatings. The first electric heating coating is located between the first electrode 13 and the third electrode, and the second electric heating coating is located between the second electrode 14 and the third electrode.

It should be noted that, the specification of this application and the drawings thereof provide preferred embodiments of this application. However, this application may be implemented in various different forms, and is not limited to the embodiments described in this specification. The embodiments are not used as an additional limitation on the content of this application, and are described for providing a more thorough and comprehensive understanding of the content disclosed in this application. Moreover, the above technical features are further combined with each other to form various embodiments not listed above, all of which shall be construed as falling within the scope of this application. Further, a person of ordinary skill in the art may make improvements or modifications based on the above descriptions, and all of the improvements and modifications shall fall within the protection scope of the appended claims of this application.

1. A heater comprising:
a base body;
an electrically conductive coating, comprising a first electrode and a second electrode formed to be spaced apart on a surface of the base body; and
an electric heating coating, formed on the surface of the base body,
wherein:
each of the first electrode and the second electrode comprises a first portion and a second portion;
the first portion of the first electrode and the first portion of the second electrode are both at least partially covered by the electric heating coating to be located between the surface of the base body and the electric heating coating, and are electrically connected to the electric heating coating; and
the second portion of the first electrode and the second portion of the second electrode are both exposed from the surface of the base body.

2. The heater according to claim 1, wherein each of the first portion of the first electrode and the first portion of the second electrode has a width ranging from 1 mm to 3 mm.

3. The heater according to claim 1, wherein the electric heating coating comprises an infrared electric heating coating, and the infrared electric heating coating is configured to generate an infrared ray when a current flows through the infrared electric heating coating, to radiatively heat an aerosol-forming substrate and generate aerosols.

4. The heater according to claim 3, wherein each of the first portion of the first electrode and the first portion of the second electrode comprises an electrode with a light transmitting gap, so that the infrared ray passes through the light transmitting gap and arrives at the surface of the base body.

5. The heater according to claim 4, wherein the light transmitting gap is in a mesh shape, and the mesh shape comprises at least one of a circle, an ellipse, a triangle, a polygon, and an irregular shape.

6. The heater according to claim 1, wherein the first portion of the first electrode and the first portion of the second electrode both extend in a length direction of the base body.

7. The heater according to claim 6, wherein each of the first portion of the first electrode and the first portion of the second electrode comprises an elongated electrode or a spiral electrode.

8. The heater according to claim 1, wherein:
the base body is constructed in an elongated tubular structure; and
the first portion of the first electrode and the first portion of the second electrode both extend in a circumferential direction of the base body, to form an annular electrode.

9. The heater according to claim 1, wherein the first portion of the first electrode and the first portion of the second electrode are symmetrically arranged with respect to each other.

10. The heater according to claim 1, wherein: the second portion of the first electrode and the second portion of the second electrode are located on a same end of the base body.

11. The heater according to claim 1, wherein:
the base body is constructed in an elongated tubular structure; and
the second portion of the first electrode and the second portion of the second electrode both extend in a circumferential direction of the base body, to form an annular electrode or an arc-shaped electrode.

12. The heater according to claim 1, wherein the second portion of the first electrode and the second portion of the second electrode both extend in a length direction of the base body.

13. The heater according to claim 1, wherein:
the electrically conductive coating further comprises a third electrode, and the third electrode comprises a first portion and a second portion; and
the first portion of the third electrode is at least partially covered by the electric heating coating to be located between the surface of the base body and the electric heating coating, and is electrically connected to the electric heating coating, and the second portion of the third electrode is exposed from the surface of the base body.

14. The heater according to claim 13, wherein:
the electric heating coating comprises a first electric heating coating located between the first electrode and the third electrode and a second electric heating coating located between the second electrode and the third electrode; and
the first electric heating coating and the second electric heating coating are configured to independently heat different parts of an aerosol-forming substrate.

15. The heater according to claim 1, wherein a thickness of the electric heating coating is in a range of 100 nm to 30 μm, a range of 300 nm to 3 μm, a range of 500 nm to 2 μm, or a range of 800 nm to 1 μm.

16. The heater according to claim 1, further comprising an anti-oxidation layer formed on the electric heating coating.

17. The heater according to claim 1, wherein the electric heating coating is formed on the surface of the base body through vapor deposition and covers at least part of the electrically conductive coating.

18. A cigarette utensil comprising:
a chamber configured to receive an aerosol-forming substrate; and
a heater configured to heat the aerosol-forming substrate, wherein the heater comprises the heater according to claim 1.

19. The heater according to claim 1, wherein each of the first portion of the first electrode and the first portion of the second electrode has a thickness less than 1 μm.

20. The heater according to claim 1, wherein the second portion of the first electrode and the second portion of the second electrode are located on different ends of the base body.
